(19) United States
(12) Patent Application Publication
(10) Pub. No.: US 2021/0088993 A1
(43) Pub. Date: Mar. 25, 2021

(54) CONTEXT DRIVEN AUTOMATION

(71) Applicant: Igor, Inc., Johnston, IA (US)

(72) Inventor: Dwight L. Stewart, Johnston, IA (US)

(21) Appl. No.: 17/026,441

(22) Filed: Sep. 21, 2020

Related U.S. Application Data
(60) Provisional application No. 62/903,241, filed on Sep. 20, 2019.
(60) Provisional application No. 62/983,353, filed on Feb. 28, 2020.
(60) Provisional application No. 62/987,139, filed on Mar. 9, 2020.

(51) Int. Cl. G05B 19/042

(52) U.S. Cl. CPC G05B 19/042; G05B 2219/2614

(57) ABSTRACT

Disclosed are systems and processes that employ context driven automation.

### CROSS REFERENCE TO RELATED APPLICATIONS

This application claims priority to U.S. Provisional Application No. 62/903,241 which was filed Sep. 20, 2019, the entity of which is incorporated herein fully by reference.

This application also claims priority to U.S. Provisional Application No. 62/983,353 which was filed Feb. 28, 2020, the entirety of which is incorporated herein fully by reference.

This application also claims priority to U.S. Provisional Application No. 62/987,139 which was filed Mar. 9, 2020, the entirety of which is incorporated herein fully by reference.

### BACKGROUND

### 1. Field

Example embodiments relate to systems and methods of controlling the systems using context driven automation.

### 2. Description of the Related Art

Most modern buildings include several electrical and mechanical systems such as HVAC systems, fire suppression systems, plumbing, and lighting systems. In 1987, BACnet protocols were developed to automate building systems. By 2001 the BACnet protocols were adopted as ISO standard 16484-5. BACnet provides a method of interoperatbility between different building systems. However, BACnet does not provide actual direct digital control of a process. It is not a control language. It does not provide a standardized method for programming or commissioning devices. In short, while BACnet has provided for effective automation of building controls, it is very complex and difficult to implement.

### SUMMARY

Example embodiments relate to systems and methods of controlling the systems using context driven automation.

Disclosed is a process used to control a system. In example embodiments, the process may include detecting an event using one of a sensor and a controller, using an associative database to determine a space associated with the one of the sensor and the controller, and controlling at least one electronic device having an identification associated with the space.

Disclosed also is a context driven automation system, comprising a controller configured to execute one or more automations upon receipt of data, wherein the controller provides an eventor reference to the one or more automations. In one embodiment the controller is configured to pair metadata with data. In another embodiment, the one or more automations is configured to request metadata. In example embodiments, the metadata may be, but is not required to be, one or more of a tag, a type of object, and a database relationship. The data may be, but is not required to be, generated by at least one of a device, a cloud device, a user action, and an API.

### BRIEF DESCRIPTION OF THE DRAWINGS

Example embodiments are described in detail below with reference to the attached drawing figures, wherein:

FIG. 1 is a view of a controller in accordance with example embodiments;

FIG. 2 is a view of a system in accordance with example embodiments;

FIG. 3 is a view of a process to control a system in accordance with example embodiments;

FIG. 4 is a view of a system in accordance with example embodiments;

FIG. 5 is a view of a process to control a system in accordance with example embodiments;

FIG. 6 is a view of a system in accordance with example embodiments;

FIG. 7 is a view of a process to control a system in accordance with example embodiments;

FIG. 8 is a view of a system in accordance with example embodiments;

FIG. 9 is a view of a process to control a system in accordance with example embodiments;

FIG. 10 is a view of a system in accordance with example embodiments;

FIG. 11A is a view of a process to control a system in accordance with example embodiments;

FIG. 11B is a view of a process to control a system in accordance with example embodiments;

FIG. 11C is a view of a process to control a system in accordance with example embodiments;

FIG. 12 is an example of a database storing preferences in accordance with example embodiments;

FIG. 13 is a schematic view of a building in accordance with example embodiments; and

FIG. 14 is a view of a system in accordance with example embodiments.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to systems and methods of controlling the systems using context driven automation.

Many modern devices provide data to a receiver, for example, a computer, which use the data to perform various functions. This data, for example, metadata, provides context which may indicate the type of device which is sending the data. For example, a temperature sensor may transmit data indicative of an environmental temperature. A motion sensor may provide data related to motion. A bed sensor may indicate whether or not a person has climbed into or out of a bed. A smoke detector may send information regarding the presence of smoke. Traditionally, the data provided by these devices has been used to perform various functions. However, the context of the data itself has not been utilized in a control system, for example, a building control system. One of the inventive concepts described in this disclosure is the utilization of context in a building control system. Use of context is quite different from traditional building control systems that utilize BACnet protocols which are quite rigid and inflexible. The disclosure below describes simple systems which illustrate the use of context in building control. The advantage of the inventor's approach, namely, using context to drive automation, is that it is easily employed and scalable.

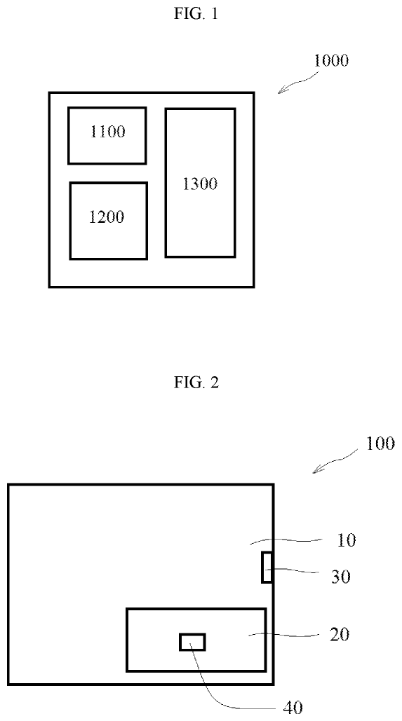

FIG. 1 is a view of a controller 1000 in accordance with example embodiments. In FIG. 1, the controller 1000 is embodied by a computer having a central processing unit 1100 and a memory 1200. The controller 1000 may further include an additional memory chip 1300 which may be used to store algorithms usable by the central processing unit 1100 to manage various systems either directly or indirectly connected to the controller 1000. Memory 1200 may be configured to store various types of data. For example, memory 1200 may store data related to various types of electrical components such as, but not limited to, lights, sensors, noise generators, and shakers. The memory 1200 may store this data in a database accessible by the central processing unit 1100. In addition to storing data related to electrical components, the memory 1200 may store additional data, for example, space control data. Generally speaking, in this application, physical building spaces may be represented by virtual spaces which may be defined by a user. A virtual space, therefore, corresponds to a physical space, for example, one or more areas, of a building. For example, in one embodiment a first space may be associated with one or more rooms or one or more hallways and a second space may be associated with other rooms or other hallways. A typical building, for example may include several spaces which may have items, for example, lights, sensors, heaters, shakers, etc. associated with them.

FIG. 2 is a view of a system 100 in accordance with example embodiments. In FIG. 2, the system 100 may include various electrical components which may be associated with or assigned to a space 10. The space 10 may be a virtual space established by a user as described above. In the example of FIG. 2 the system 100 includes electrical components associated with a single space, but this is not intended to limit the invention as system 100 may include various electrical components assigned to more than one space. Regardless, for purposes of illustration, the system 100 of FIG. 2 includes electrical components associated with a single space 10. Associated with space 10 is a bed 20, a light 30, and a sensor 40, the light 30 and sensor 40 being examples of electrical components associated with space 10. In this particular nonlimiting example embodiment, the electrical components associated with space 10, namely the light 30 and the sensor 40, may each have an identification number or symbol which may be stored in a database, for example, an electronic database associated with memory 1200. In this particular nonlimiting example embodiment, a user of the system may use the electronic database 1200 to associate the light 30 and the sensor 40 with space 10.

The light 30 and the sensor 40 may be operatively connected to the controller 1000. For example, light 30 and the sensor 40 may send and receive data from the controller 1000 and the controller 1000 may control the light 30 and the sensor 40 based on data received from the sensor 40. Data may be exchanged between the controller 1000, the light 30, and the sensor 40 by wire or wirelessly. In this nonlimiting example, the light 30 may be designated as a nightlight by using a tag. For example, the following tag may be assigned to the light 30: Light30#Nightlight. Similarly, the following tag may be assigned to sensor 40: bedsensor40#sensor. These tags may thereafter be associated with space 10 via a database relationship which may be stored in a database of memory 1200. Thereafter, an automation that uses context (for example, relationships and tags) may be used to produce a desired behavior. The automation may be executed by microprocessor 1100 which may cause the controller 1000 to send control information to the light 30 and/or sensor 40.

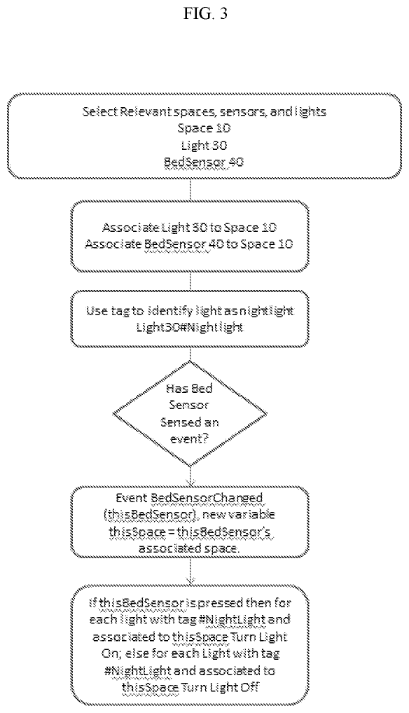

FIG. 3 is a flowchart of a view showing an example automation usable with system 100. As shown in FIG. 3, a user may select relevant spaces, lights, and sensors and, thereafter, utilize a database relationship to associate the light 30 and sensor 40 to the space 10. For example, one may associate light 30 to space 10 and sensor 40 to space 10. As mentioned above, tags may be used to designate the light 30 as a nightlight (e.g. Light30#Nightlight) and the sensor 40 as a bed sensor (e.g. sensor40#bedsensor). An automation may be created in consideration of the selected equipment, the database relationship, and the tags. For example, as shown in FIG. 3, if the bed sensor 40 detects an event (for example, a person climbing into a bed) then the automation may set a new variable (thisSpace) equal to the bed sensor's associated space, which in this case is space 10. If the bed sensor 40 is pressed then for each light in space 10 having the tag “#NightLight” and associated with space 10 will turn on. Otherwise, if the sensor 40 is not pressed, then for each light with tag #NightLight and associated with this space will turn off. This very simple routine is merely an illustration of the invention.

As one skilled in the art would readily appreciate, a building, for example, a dormitory or nursing home, could have dozens if not hundreds of room similar to that represented by system 100. Each may have its own bed, sensor, and nightlight. A user may associate each of the bed, sensor, and nightlight with a space using a database relationship as described above. For example, a second room may have a second bed, a second bed sensor, and a second nightlight. The area of the second room could defined as a second space and the second bed sensor and second nightlight could be associated with the second space in a database type relationship. In this case, the system in the second room may use the same automation as provided for in the first room. For example, in this latter case if the second bed sensor sensed someone climbed out of the second bed then the new variable would be defined as the second bed sensor's space (i.e. thisSpace=thisBedSensor's Space=Space 2) and the nightlight associated with the second space would turn on. Clearly this may be repeated for dozens of not hundreds of rooms. Thus, in the disclosed system, hundreds of rooms with beds and nightlights may be managed by use of a single automation that is invoked when a person climbs out of a bed.

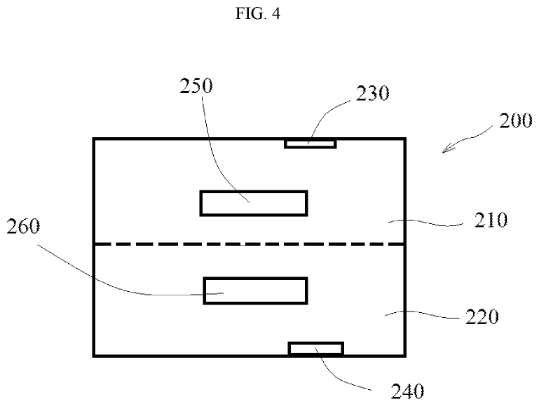

FIG. 4 is a view of a system 200 in accordance with example embodiments. In FIG. 4, the system 200 may include a first space 210, a second space 220, a first motion sensor 230 in the first space 210, and a second motion sensor 240 in the second space 220. The first space 210 may further include a first light 250 and the second space 220 may include a second light 260. The spaces 210 and 220 may be virtual spaces established by a user as described above. In the example of FIG. 4 the system 200 includes two spaces, but this is not intended to limit the invention as the system 200 may include more than two spaces or only a single space. Regardless, for purposes of illustration, the system 200 of FIG. 4 includes two spaces 210 and 220. In this particular nonlimiting example embodiment, the electronic components associated with spaces 210 and 220, namely the motions sensors 230 and 240 and the lights 250 and 260, may each have an identification number or symbol which may be stored in a database which associates the motion sensors 230 and 240 and lights 250 and 260 with spaces 210 and 220. For example, the first motion sensor 230 and the first light 250 may be associated with the first space 210 and the second motion sensor 240 and the second light 260 may be associated with the second space 220. In example embodiments, the motion sensors 230 and 240 and the lights 250 and 260 may be operatively connected to the controller 1000. For example, the first and second motion sensors 230 and 240 and the first and second lights 250 and 260 may send and receive data from the controller 1000 and the controller 1000 may control the first and second motion sensors 230 and 240 and the first and second lights 250 and 260. In this nonlimiting example, the electronic components may be associated with their spaces using a database relationship. For example, the first motion sensor 230 and the first light 250 may be associated with the first space 210 and the second motion sensor 240 and the second light 260 may be associated with the second space 220. In example embodiments an automation may be created that uses context (e.g. relationships) to produce a desired behavior.

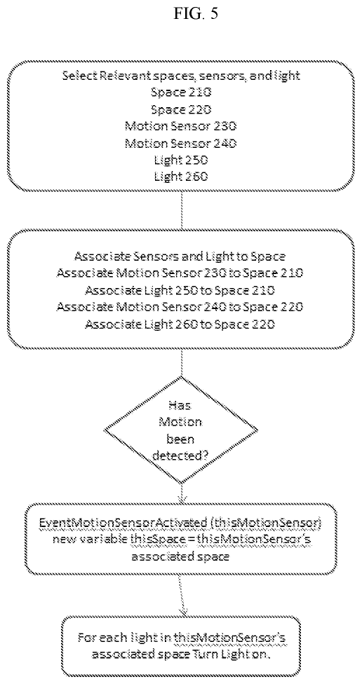

FIG. 5 is a flowchart of a view showing an example automation usable with system 200. A user may identify the relevant spaces (210 and 220), sensors (230 and 240) and lights (250 and 260). Thereafter, the sensors 230 and 240 and the lights 250 and 260 may be associated with their spaces via a database relationship. For example, sensor 230 and light 250 may be associated with the first space 210 and the sensor 240 and the light 260 may be associated with the second space 220. As shown in FIG. 5, if a motion sensor is activated then an automation is executed by controller 1000. For example, if the first motion sensor 230 is activated, then the controller may receive a signal from the first motion sensor 230 and then determine the space associated with the first motion sensor 230. The controller 1000 would then use this space as a variable and turn on all lights that have a space the same as the variable which, in this case would be light 250. For example, if motion sensor 230 detected a motion, a signal from motion sensor 230 would be sent to controller 1000 which would use a database to determine a new variable thisSpace as space 210 (Motion Sensor 230′s associated space, 210). The controller 1000 would then turn on each light associated with space identical to thisSpace, that is lights associated with space 210, which is light 250. Similarly, if motion Sensor 240 detected a motion, a signal from motion sensor 240 would be sent to controller 1000 which would use a database to determine a new variable thisSpace as space 220 (motion sensor 240′s associated space, 220). The controller 1000 would then turn on each light associated with space identical to thisSpace, that is lights associated with space 220, which is light 260.

It is clear that a building could have dozens, if not hundreds, if not thousands of rooms having motion sensors and lights. This same routine may be used by the controller 1000 upon receipt of any signal from a motion detector.

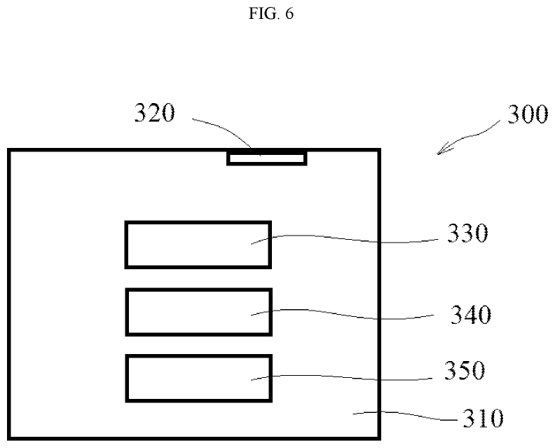

FIG. 6 is a view of a system 300 in accordance with example embodiments. In FIG. 6, the system 300 may include a first space 310, an audio sensor 320, for example, a gunshot sensor, a first light, 330, a second light 340, and a sound emitter 350, for example, a buzzer. The space 310 may be a virtual space established by a user as described above. In the example of FIG. 6 the system 300 includes a single space, but this is not intended to limit the invention as the system 300 may include more than one space. Regardless, for purposes of illustration, the system 300 of FIG. 6 includes a single space 310. In this particular nonlimiting example embodiment, the electronic components associated with spaces 310, namely the audio sensor 320, the lights 330 and 340, and the sound emitter 350, may each have an identification number or symbol which may be stored in a database which associates the audio sensor 320, the lights 330 and 340, and the sound emitter 350, with space 310. In example embodiments, the audio sensor 320, lights 330 and 340, and the sound emitter 350 may be operatively connected to the controller 1000. For example, the audio sensor 320, the first and second lights 330 and 340, and the sound emitter 350, may send and receive data from the controller 1000 and the controller 1000 may control each of the audio sensor 320, the first and second lights 330 and 340, and the sound emitter 350. In this nonlimiting example, the electronic components may be associated with their space using a database relationship. For example, the audio sensor 320, the first and second lights 330 and 340, and the sound emitter 350 may be associated with the space 310. In example embodiments an automation may be created that uses context (e.g. relationships) to produce a desired behavior.

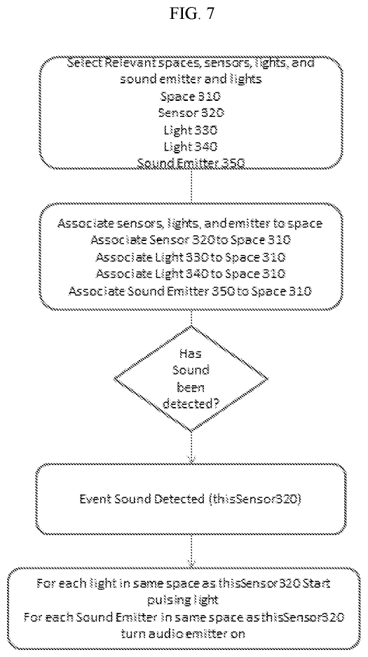

FIG. 7 is a flowchart of a view showing an example automation usable with system 300. As shown in FIG. 7, a user may select relevant spaces, sensors, lights, and sound emitters. Thereafter, the sensors, lights, and sound emitters are associated with a space. For example, each of the audio sensor 320, the lights 330 and 340 and the sound emitter 350 may be associated with the first space. As shown in FIG. 7, if the audio sensor 320 senses a sound, for example, a gunshot, then an automation is executed by controller 1000. For example, if audio sensor 320 is activated, then the controller 1000 may receive a signal from the audio sensor 320 and then determine the space associated with the audio sensor 320 by using the previously defined associations. The controller 1000 would then use this space as a variable and control the lights associated with this space to execute to blink on and off while controlling the sound emitter 350 associated with this space to emit a sound.

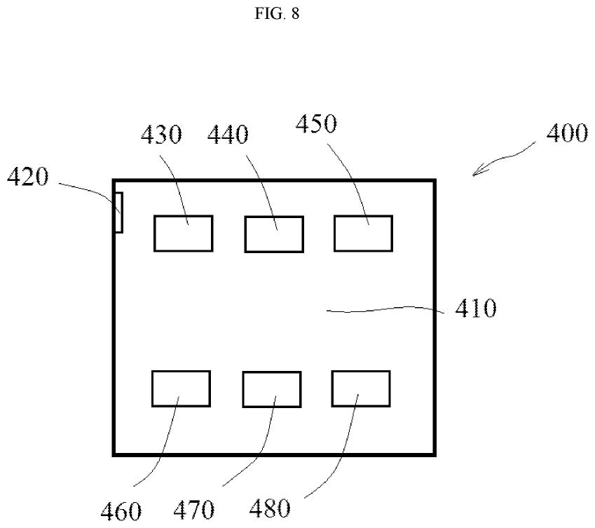

FIG. 8 is a view of a system 400 in accordance with example embodiments. In FIG. 8, the system 400 may include a first space 410, a wall controller 420, and a plurality of lights 430, 440, 450, 460, 470, and 480. The space 410 may be a virtual space established by a user as described above. In the example of FIG. 8 the system 400 includes a single space, but this is not intended to limit the invention as the system 400 may include more than one space. Regardless, for purposes of illustration, the system 400 of FIG. 8 includes a single space 410. In this particular nonlimiting example embodiment, the electronic components associated with space 410, namely the wall controller 420 and the lights 430, 440, 450, 460, 470, and 480, may each have an identification number or symbol which may be stored in a database which associates the wall sensor 420 and the lights 430, 440, 450, 460, 470, and 480, with space 410. In example embodiments, the wall controller 420 and the lights 430, 440, 450, 460, 470, and 480 may be operatively connected to the controller 1000. For example, the wall controller 420 and the lights 430, 440, 450, 460, 470, and 480, may send and receive data from the controller 1000 and the controller 1000 may control each of the wall controller 420 and the lights 430, 440, 450, 460, 470, and 480. In this nonlimiting example, the electronic components may be associated with their space using a database relationship. For example, wall controller 420 and the lights 430, 440, 450, 460, 470, and 480 may be associated with the space 410. In example embodiments an automation may be created that uses context (e.g. relationships) to produce a desired behavior. Further yet, a tag may be used to designate the lights as either in the front of the room or the back of the room to provide for additional control. For example, the first, second and third lights 430, 440, and 450, may be assigned the following tags, respectively: Light430#front, Light440#front, and Light450#front. Similarly, the fourth, fifth, and sixth lights 460, 470, and 480 may be assigned the following tags, respectively: Light460#back, Light470#back, and Light480#back.

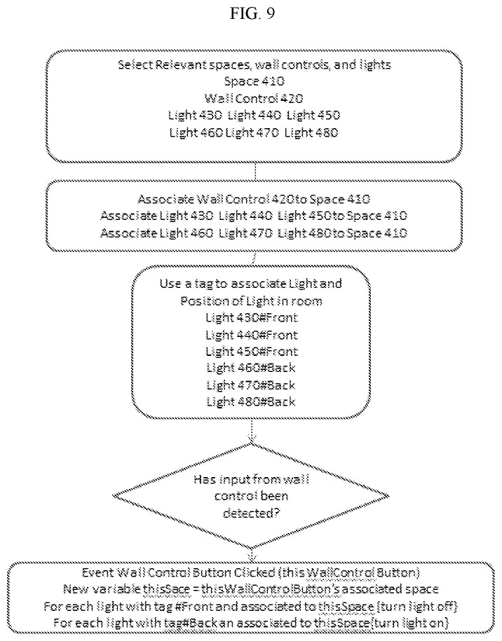

FIG.9 is a flowchart of a view showing an example automation usable with system 400. As shown in FIG. 9, if the wall controller 420 is controlled by a user who wishes to dim the lights in the front of the room (for example, to put the room in presentation mode by turning off the lights in the front of the room and turning on the lights in the back of the room), the user would operate the wall controller 420 so that a signal corresponding to a presentation mode is desired. The signal would be received by the controller 1000 who would use this signal to determine what space the wall control was in then, and then us this space as a new variable. The controller 1000 thereafter would turn off the lights that have the tag #front in the space and turn on lights having the tag # back associated with this space.

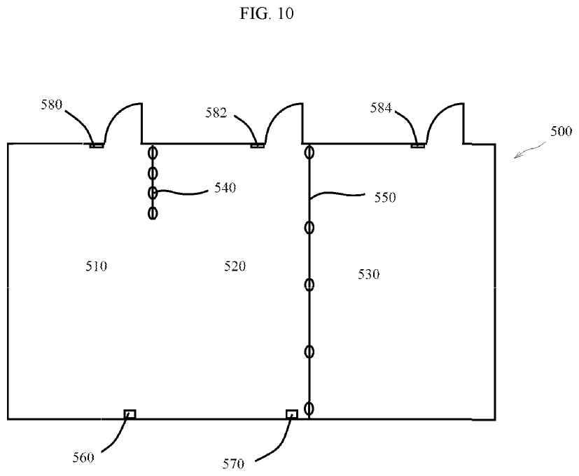

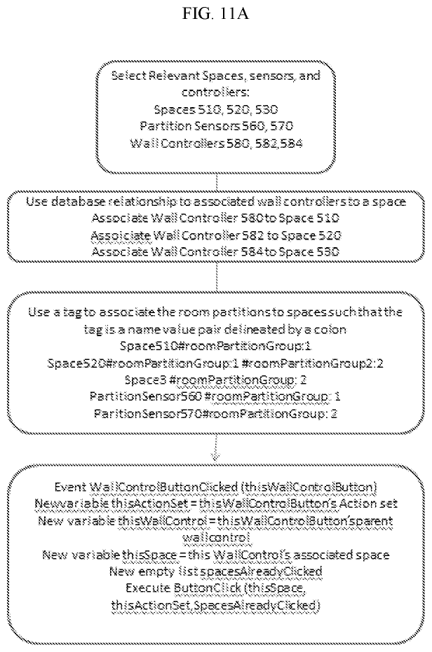

FIG. 10 is a view of a system 500 in accordance with example embodiments. In FIG. 10, the system 500 may resemble a large room which may be partitioned, virtually, into a first space 510, a second space 520, and a third space 530. The system 500 may include a first partition 540 and a second partition 550 which may be extended or retracted to cause physical separation in space and create partition groups. For example a first partition group may consist of spaces 510 and 520 (when the second partition 550 is extended) and a second partition group may consist of spaces 520 and 530 (when partition 540 is extended). As shown in FIG. 10, the system 500 further includes partition sensors 560 and 570 which may sense whether the partitions are extended or retracted. The system 500 further includes wall controllers 580, 582, and 584 to control various types of equipment (for example, lights).

It may be desirable that a wall controller control lights in one space only when a partition is closed. It may also be desirable for a single controller to control lights in multiple spaces when a partition is open. To accomplish this, a database relationship along with an automation may be created. For example, wall control 580 may be associated with space 510, wall control 582 may be associated with space 520, and wall control 584 may be associated with space 530. Tags may be used to associate room partitions to spaces. In this example, the tag may be a name value pair delineated by a colon. By way of illustration only, the tags may be defined as
Space510#roomPartitionGroup: 1
Space520#roomParticipationGroup:1#roomPartitionGroup:2
Space530#roomParticipationGroup:2
PartitionSensor560#roomPartitionGroup:1
PartitionSensor570#roomPartitionGroup:2

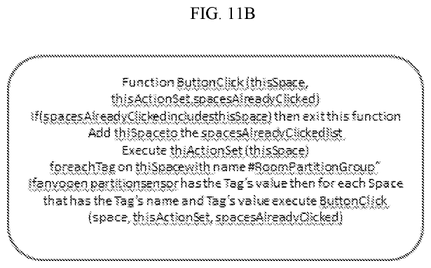

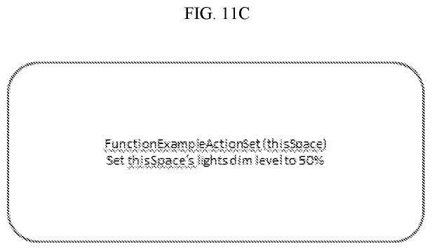

FIGS. 11A-11C illustrate an example of an automation that may be executed by the controller 1000. FIG. 11A illustrates how several variables are defined based. In particular, the variables that are defined are
NewvariablethisActionSet =thisWallControlButton'sActionSet (which is illustrated in FIG. 11C).
newvariablethisWallControl=thisWallControlButton's parent wall control.
New variable thisSpace=thisWallControl's associated space.
New empty list spacesAlreadyClicked

After the variables are set, a FunctionButtonClick routine may be executed using the thisSpace, thisActionset, and spacesAlreadyClicked variables. In this routine, the controller 1000 executes the automation illustrated in FIG. 11B to turn on and off lights based on whether the partitions are extended or retracted.

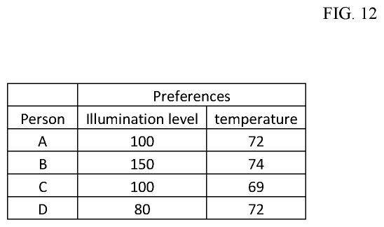

The above examples are not meant to limit the inventive concepts disclosed herein. For example, as another example of an inventive concept, FIG. 12 illustrates a database containing a preferences of various people. In FIG. 12, the people are identified by the letters A, B, C, D which may represent a person's name or some symbol, for example, an identification number, associated with the person. By way of example only, the database in FIG. 12 illustrates data for four people, however, it is understood the database may store information for hundreds if not thousands of people. Referring again to FIG. 12, the preferences may include, but not be limited to, a room temperature or a brightness in a room. For example, person A may prefer a room having a standard illumination level of 100 and a room temperature of 72 degrees F. Person B may prefer a room which is 50% brighter than a standard illumination level and may prefer a slightly warmer room of 74 degrees F. Person C may desire a room having a standard illumination level of 100 and a slightly cooler room of 69 degrees F. Finally, person D may prefer a dimmer room (for example, 80% of a standard illumination value) and a room temperature of 72 degrees F. It is understood the database of FIG. 12 could store a multitude of other preferences besides the illumination level and temperature.

In this particular nonlimiting example embodiment a person may be fitted with a tracker, for example, a phone radio signature, an ID badge (for example, an RFID badge), or some other tracker. The tracker may send a signal which may be received by an electronic node or some other local transceiver picking up the person's tracker. When the person is sensed in a space, for example, a room, a controller may automatically adjust various devices in the space to match the person's preference. For example, a person suffering macular degeneration may prefer a room having a certain level of illumination which may be stored as a preference in the database of FIG. 12. Thus, when this person is detected walking into a space, the controller may control the lights in the room to have the preferred level of illumination. As yet another example, when the person is sensed in the room the controller may control an air conditioning to bring the temperature in the space to a desired temperature.

In example embodiments, the aforementioned controller may be local to a space. For example, when the inventive concepts are implemented in a nursing home, various spaces may be fit with various controllers which locally control the spaces. In the alternative, a single controller may be used to control the spaces throughout the nursing home and the controller may utilize the database of FIG. 12 which may store data for all of the residents of the nursing home.

In example embodiments the controller may execute an automation when only a single person is in a space to match that person's preferences. When two or more people are detected in the space the controller may execute a rule to determine how to control devices associated with the space. For example, a hierarchy amongst persons may exist and the controller may control a space based on the hierarchy. For example, if a husband and wife share a room, and the husband and wife have different preferences, and the hierarchy indicates the wife's preferences take precedence over the husband's preferences, the controller may control the space based on the wife's preferences. In the alternative, when two people are detected in a space, the controller may control the devices in the space on a default value.

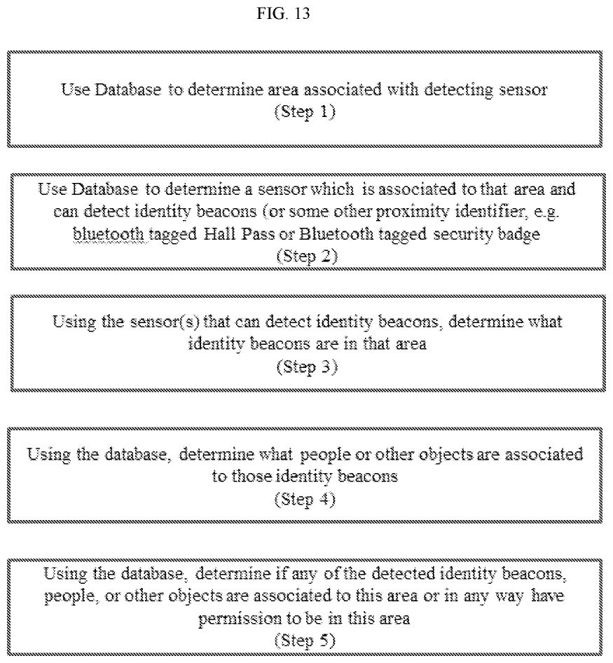

FIG. 13 is a view of a method in accordance with at least one of the inventive concepts described herein. As one skilled in the art would readily appreciate, the method of claim 13 can be operated on a computer system comprised of processors, electronic databases, sensors, and identity beacons. As shown in FIG. 13, the method may begin with a first step (step 1) where a database is used to determine an area associated with a detecting sensor. The detecting sensor may, by way of example only, be a motion sensor, a proximity sensor, or an asset tracking sensor. This step may be followed by a second step (step 2) where a database is used to determine at least one sensor which is associated to that area and can detect identity beacons (or some other proximity identifier), for example, bluetooth tagged Hall Pass and/or Bluetooth tagged security badge. The aforementioned sensor may be configured to detect multiple types of identity beacons, for example, the sensor may detect each of the exemplary beacons (Bluetooth tagged Hall Pass and/or Bluetooth tagged security badge) and may also detect motion. Thus, the sensor of step 2 may be the same as the sensor of step 1. It is understood that some identity beacons may have identifiers that change over time based on a security algorithm, as such, there may be a need to decipher prior to a database lookup. The method may further include the step of using the sensors that can detect identity beacons to determine what identity beacons are in that area (step 3). The method may further include the step of using a database to determine what people or other objects are associated with those identity beacons (step 4). The method may further include a step of using a database to determine if any of the detected identity beacons, people, or other objects are associated to this area or in any way have permission to be in this area (step 5). If not detected, then event (through an API or otherwise) that “unauthorized” motion was detected in that area, and optionally provide a list of all the detected identity beacons in that area. The method may also include the following steps: using a database, determine if any of the detected identity beacons, people, or other objects are in any way explicitly prohibited from this area; and if detected, then event (through API or otherwise) that “unauthorized” motion was detected in that area, and optionally provide a list of all the detected identity beacons in that area.

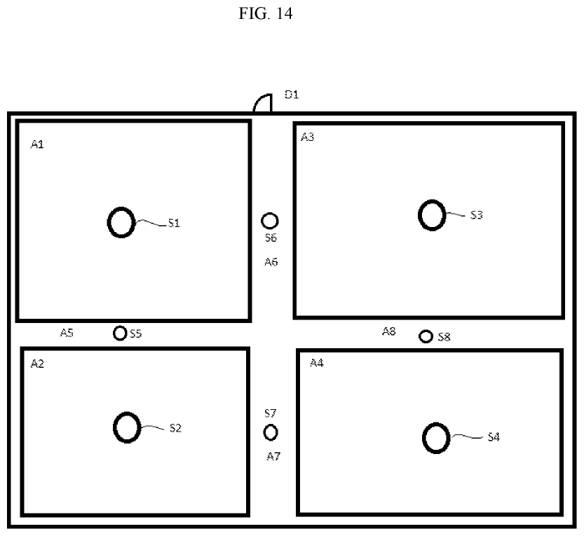

FIG. 14 is an example of a system in which the above described method may be implemented. The system may be implemented in a building with several rooms and hallways, a nonlimiting example being shown in FIG. 14. As shown in FIG. 14, the building may have a floor with four rooms A1, A2, A3, and A4 and four hallways A5, A6, A7, and A8. The first room may include sensor S1, the second room may include sensor S2, the third room may include sensor S3 and the fourth room may include the sensor S4. Each sensor S1, S2, S3, and S4 may detect motion in their respective rooms. The rooms A1, A2, A3, and A4 may be associated with the sensors S1, S2, S3, and S4 in an electronic database. The hallways A5, A6, A7, and A8 may likewise be associated with sensors S5, S6, S7, and S8 in the electronic database. In this nonlimiting example embodiment, each of the sensors S1 to S8 may be configured to detect an identity beacon such as, but not limited to, a security badge, a hall pass, or an identification card. In this nonlimiting example embodiment, a person may be authorized to enter the building through door D1 and may be authorized to walk through the hallways A5, A6, A7, and A8 and may enter room A1, but not be authorized to enter rooms A2, A3, and A4. In this example, the person entering the building may walk through hallway A6 and the sensor S6 may detect motion in the hallway and may detect an identity beacon worn by the person (for example, a security badge). Upon detecting the security badge the building control system may be determine the wearer of the badge via an electronic table which associates the security badge to the person. The electronic table may also include information regarding which rooms the person may enter, which, in this case, is rooms A1 and A5-A8. Thus, the building control system may determine that the person is authorized to be in hallway A6. If the person enters room A1 the person may be sensed by sensor S1 and the sensor S1 may determine the identity beacon. The building control system may then use this data to look up whether the person is authorized to be in room A1. If so, no further action may be required. However, if the person enters room A2, the sensor S2 may determine the identity beacon and the building control system may identify the person and the person's permissions, which do not include access to room A2. Thus, the building control system may automatically create an event and may send a message to building security that an unauthorized access to room A2 has occurred. It is understood that this example is for purpose of illustration and is not meant to limit the invention or inventive concepts recited herein.

The above method has a number of relevant and practical uses. For example, in a first scenario, the area may be a school, and a child with a bathroom pass is permitted to travel between a classroom and a bathroom. However, as is common with school children, the child may inadvertently go to the gym or an unscheduled classroom to meet a friend. The above method is useful for tracking students and determining whether they are authorized to be in a particular area and alert an authority they are not in an allowed area. As a second scenario, the method is useful for detecting a breakin, for example, a breakin in a data center, and identifying all parties who may be in the area where the breakin occurs. As a third scenario, the above method is useful in managing people in a corporate building. For example, the method, when implemented, may detect when a visitor walks away from a chaperone and enters a part of the building not permitted for visitors. As yet another example, it may be useful for detecting when an employee enters and area, for example, a CFO's office, without authorization when the CFO is gone.

Example embodiments of the disclosure have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present disclosure may be practiced otherwise than as specifically described.

1. A context driven automation system, comprising:
a controller configured to execute one or more automations upon receipt of data, wherein the controller provides an eventor reference to the one or more automations.

2. The system of claim 1, wherein the controller is configured to pair metadata with data.

3. The system of claim 2, wherein the metadata is an IP address.

4. The system of claim 2, wherein the metadata is a tag.

5. The system of claim 2, wherein the metadata is a type of object.

6. The system of claim 2, wherein the metadata is a database relationship.

7. The system of claim 1, wherein the one or more automations is configured to request metadata.

8. The system of claim 7, wherein the metadata is an IP address.

9. The system of claim 7, wherein the metadata is a tag.

10. The system of claim 7, wherein the metadata is a type of object.

11. The system of claim 7, wherein the metadata is a database relationship.

12. The system of claim 1, wherein the data is generated by a device.

13. The system of claim 1, wherein the data is generated by a cloud device.

14. The system of claim 1, wherein the data is generated from user action.

15. The system of claim 1, wherein the data is generated by an API.
